(19) United States
(12) Patent Application Publication
(10) Pub. No.: US 2002/0068485 A1
(43) Pub. Date: Jun. 6, 2002

(54) Electronic device

(76) Inventors: Dieter Busch, Rosbach (DE); Reinhold Berberich, Frankfurt (DE)

Correspondence Address: Martin A. Farber, Suite 473, 866 United Nations Plaza, New York, NY, 10017, US

(21) Appl. No.: 09/960,869

(22) Filed: Sep. 21, 2001

(30) Foreign Application Priority Data
Sep. 22, 2000 (DE) 100 47 065.3

(51) Int. Cl. H01R 13/66; H01R 33/945

(52) U.S. Cl. 439/620

(57) ABSTRACT

The invention relates to an electronic deice with a contact device attached to an electrically conducting housing, which has at least one plug-in element to establish electrical contact with an electrical circuit disposed in the housing, a capacitor being provided to improve the electromagnetic sensitivity of the electric circuit.

In an electric device which is also suitable for mass production, a simple and inexpensive interference-suppression measure is implemented by designing the plug-in connector element itself as a capacitor.

The invention relates to an electronic device with a contact device attached to an electrically conducting housing, which has at least one plug-in element to establish electrical contact with an electrical circuit disposed in the housing, a capacitor being provided to improve the electromagnetic sensitivity of the electric circuit.

In order to guarantee fault-free function of electronic devices, it is necessary to protect these against radiated interference which occurs in particular in the radio frequency range. Such interference-suppression measures are carried out on a printed circuit board located inside the electronic device, in which a capacitor is connected to line and ground potential. Standard capacitors which are soldered into metal housings and which require expensive and elaborate processing are normally used for interference suppression.

The object of the invention is therefore to indicate a simple and inexpensive interference-suppression measure for electronic devices which is also suitable for mass production.

The object is achieved according to the invention by designing the plug-in element itself designed as a capacitor.

The invention offers the advantage that the interference suppression is already performed on the outside of the electronic device and radiated interference does not even reach the inside of the housing,

The plug-in element advantageously has an electrically conducting sleeve, which encloses at a distance an electrically conducting pin which projects beyond the sleeve into the inside of the housing, the area between the sleeve and the pin being filled with a dielectric medium and the sleeve been connected to a first electrical potential and the pin to a second electrical potential. On the basis of this design, no assembly step is required in manufacturing the electronic device, since the plug-in connector already contains the interference-suppression capacitors.

No additional fixing devices are required on the housing, if the sleeve and a plug-in body of the contact device are manufactured as a single unit comprising electrically conducting material.

In a preferred embodiment, the sleeve is electrically connected to the housing potential. This is advantageously achieved by placing the sleeve on the side and/or on top of the housing.

In a particularly simple method for establishing the connection to the housing potential, the sleeve is inserted into the housing in a frictional and/or interlocking manner. The assembly of the entire plug-in connector is reduced to a single insertion process for the signal and housing contacts if the surface of the sleeve has means which engage in a housing opening, preferably locking means for anchoring.

Together with the plug-in connector device, the capacitors represent a structural unit if the sleeve encloses a plurality of pins.

The pin is advantageously designed as an insertion contact for the electronic circuit, this contact being established immediately when the plug-in connector is assembled.

Due to the design of the plug-in connector as a capacitor, it is possible for the electrical device to comprise an electrically conducting but non-solderable external housing, whereby the housing can be manufactured using an aluminum die casting method.

The invention permits numerous embodiments. One of these will be explained in detail with reference to the figure shown in the drawing, in which:

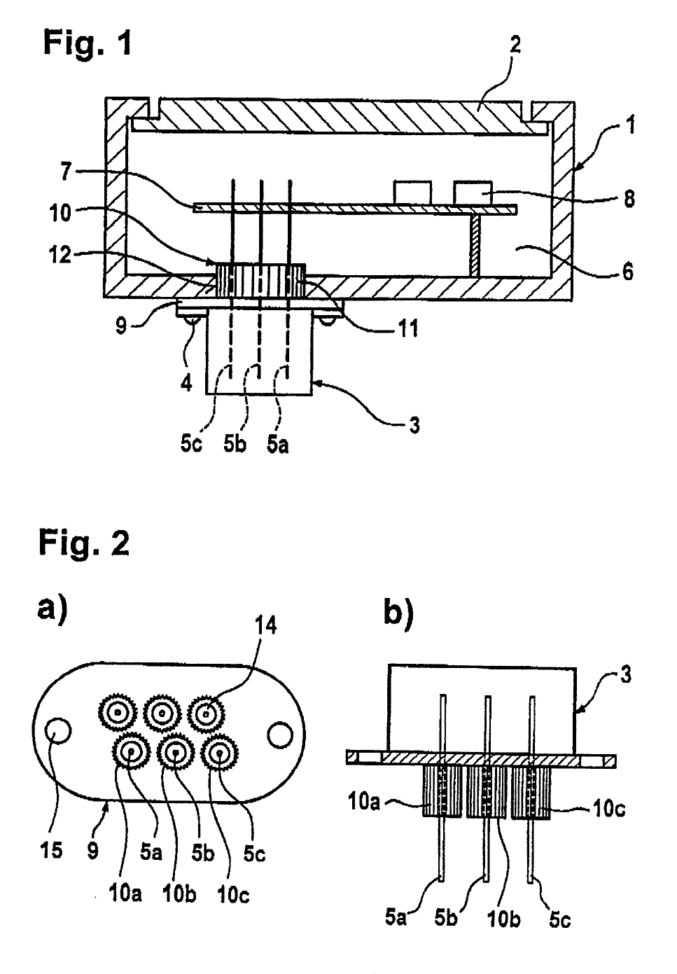

FIG. 1 shows a section through a control device with a first embodiment of the plug-in connector device according to the invention,

FIG. 2 shows a second embodiment of the plug-in connector device.

The same features are indicated by the same reference numbers.

FIG. 1 shows an electrical device of the type normally used in motor vehicles. This may involve a control device of a motor vehicle which has a signal-processing electronic system, which is known to be very sensitive to high frequencies. However, it is also conceivable for the electronic device to represent a sensor device which, along with an actual sensor, has a signal-processing circuit and/or a signal-evolution circuit, which are disposed on one or more printed circuit boards.

The electronic device has a cup-shaped housing part 1 made of aluminum, which is sealed with a cover 2. The cup-shaped housing part 1 has a plug-in connector body 3 which is attached to the outside of the housing part 1 by means of screws or rivets 4. The plug-in connector pins 5 of the plug-in connector body 3 project both into the plug-in connector body 3 and into the inside of the housing 6. The plug-in connector 3 connects the circuit of the device via the plug-in connector pins 5 to other electrical and electronic devices in the motor vehicle.

The inside of the housing 6 contains at least one printed circuit board 7 which carries structural elements 8 which implement the electronic circuits. The plug-in connector pins 5 projecting into the inside of the housing 6 are electrically connected to the structural component 8 located on the printed circuit board 7 to supply signals and electrical power. A metal sleeve 10, which partially encloses the plug-in connector pins 5, is disposed in a plug-in connector area 9 placed on the outside of the housing part. The outside of this metal sleeve 10 has circumferential projections, which are advantageously designed as grooves. These grooves enable insertion and fixing of the plug-in connector 3 in a housing opening 12. This eliminates the need for the screws to attach the plug-in connector 3 to the housing. The plug-in connector pins 5a, 5b, 5c are inserted into the printed circuit board 7 which carries the electronic circuit. This is carried out in an assembly step with the insertion of the plug-in connector 3 into the housing 1.

FIG. 2 shows a different embodiment of the plug-in connector according to the invention. Various plug-in connector pins 5a, 5b, 5c are disposed on the plug-in connector area 9 which forms the plug-in connector base, each plug-in connector pin 5a, 5b, 5c being enclosed in each case by its own metal sleeve 10a, 10b, 10c. A space, which is filled with a dielectric medium, exists between the relevant plug-in connector pin and the associated metal sleeve. As shown in FIG. 2b, the sleeves 10a, 10b, 10c are drawn only partially over the relevant plug-in connector pin 5a, 5b, 5c. These thus form a feed-through capacitor.

If the sleeves 10a, 10b, 10c and the plug-in connector body 3 are manufactured as a single unit from electrically conducting material, this eliminates the need to attach the plug-in connector unit via the holes 15.

The arrangement according to the invention serves to protect e.g. an electronic system located within an aluminum die-cast housing against radio frequency interference

1. An electronic device with a contact device attached to an electrically conducting housing, which has at least one plug-in element to establish electrical contact with an electrical circuit disposed in the housing, a capacitor being provided to improve the electromagnetic sensitivity of the electric circuit, characterized in that the plug-in connector element (5a, 10a; 5b, 10b; 5c, 10c) is designed as a capacitor.

2. The electronic device as claimed in claim 1 characterized in that the plug-in connector element (5a, 10a; 5b, 10b; 5c, 10c) has an electrically conducting sleeve (10a, 10b, 10c), which encloses at a distance an electrically conducting pin (5a, 5b, 5c) which projects beyond the sleeve (10a, 10b, 10c) into the inside of the housing (6), the space between the sleeve (10a, 10b, 10c) and the pin (5a, 5b, 5c) being filled with a dielectric medium (14), and the metal sleeve (10a, 10b, 10c) being connected to a first electrical potential and the pin (5a, 5b, 5c) being connected to a second electrical potential.

3. The electronic device as claimed in claims 1 and 2, characterized in that the sleeve (10a, 10b, 10c) and a plug-in connector body (3) of the contact device are manufactured in a single unit from electrically conducting material.

4. The electronic device as claimed in claim 2, characterized in that the sleeve (10a, 10b, 10c) is electrically connected to the housing potential.

5. The electronic device as claimed in claim 4, characterized in that the sleeve (10a, 10b, 10c) is placed on the side or on top of the housing (1).

6. The electronic device as claimed in claim 5, characterized in that the sleeve (10a, 10b, 10c) is inserted in a frictional and/or interlocking manner in the housing (1).

7. The electronic device as claimed in claim 6, characterized in that the upper surface of the sleeve (10) has means (11), preferably locking devices for anchoring, which engage in a housing opening (12).

8. The electronic device as claimed in claim 2, characterized in that the sleeve (10) encloses a plurality of pins (5a, 5b, 5c).

9. The electronic device as claimed in claim 2, characterized in that the pin (5a, 5b, 5c) is designed as an insertion contact for the electrical circuit.

10. The electronic device according to one of the previous claims, characterized in that the housing (1) is formed from an aluminum die casting.
